(19) United States
(12) Patent Application Publication
(10) Pub. No.: US 2020/0107677 A1
(43) Pub. Date: Apr. 9, 2020

(54) HOOD DEVICE FOR GRILL

(71) Applicant: Joseph Chung, Norwalk, CA (US)

(72) Inventor: Joseph Chung, Norwalk, CA (US)

(21) Appl. No.: 16/151,159

(22) Filed: Oct. 3, 2018

(51) Int. Cl. A47J 37/07

(52) U.S. Cl. CPC A47J 37/0786; F24C 15/20; A47J 37/0718

(57) ABSTRACT

A hood device for grill includes a hood wherein a first grease collector is attached to the hood; a telescoping tube for adjusting distance between the hood and the grill, wherein one end thereof is connected to the hood; a grease filter box connected to the other end of the telescoping tube; a filter removably received within the grease filter box in a slanted direction with respect to a gravitational direction; a secondary grease collector removably received within the grease filter box; and a spring balancer attached to an outer surface of the grease filter box.

### FIELD OF THE INVENTION

The present invention relates to a hood device for grill, and more particularly, a hood device for grill having a hood, a first grease collector, a telescoping tube, a grease filter box, a filter, a second grease collector, and a balancer.

### BACKGROUND OF THE INVENTION

Many restaurants, especially Korean barbecue restaurants have been cooking food on a grill, roaster, or a stove at a dining table to serve warm dishes and keep food warm. These restaurants have necessarily equipped with hood devices above each table for inhaling and ventilating cooking fumes, smokes, odors and the like from the grill, and drawing grease and dirt through a filter out of the fumes and smokes.

Conventional hood devices include an exhaust hood that is mounted on a ceiling or a wall. However, the ceiling- or wall-mounted hood has a limitation to completely exhaust the smoke and odors from the grill due to a far distance between the grill and the hood. As a result, customers and restaurant workers are exposed to high levels of cooking oil fumes and smokes.

In order to solve this problem, there has been proposed a variety of hood devices having telescoping pipes so that the hood can be lowered closely to the grilling food to collect smokes more efficiently. For example, U.S. Pat. No. 8,079,359 proposed a hood device having a hood, a telescoping tubing, a filter assembly, a grease cup, and an external fan. In this configuration, the telescoping tubing enables the hood to be positioned adjacent to the grill to collect smokes more efficiently. In order to hold, raise, and lower the hood more smoothly, the telescoping tubing comprises a spring counterbalance device. Moreover, the concentric and cylindrical filter assembly is disposed at a lower end of the telescoping tubing to filter out grease, dirt, or debris in smokes.

However, in the case of the hood device as described above, a wire rope of the spring counterbalance device is located within the telescoping tubing; thus, grease, dirt, or debris in smokes is inevitably accumulated along the wire rope, which not only prevents the telescoping tubing from smoothly raising or lowering the hood, but also lowers a durability of the wire rope. Furthermore, concentric and cylindrical filtering layers of the filter assembly is less efficient in collecting grease, dirt, or debris. Moreover, the grease cup disposed at the bottom of the filter assembly is bulky and protruding from the hood to occupy vertical space, which prevents the hood from getting closer to the grill. Additionally, the presence of the filter assembly and grease cup sitting within the hood increases an overall weight of the portion that a user needs to lift, which disturbs smooth movement of the telescoping tubing.

Therefore, there is a need for a hood device that can be more smoothly and conveniently raised or lowered close to a grill, while having a filtering system which can more efficiently filter out grease, dirt and the like in smokes but, nonetheless, the filtering system does not interfere with smooth movement of the hood. This invention is directed to address the above problems and satisfy a long-felt need.

### SUMMARY OF THE INVENTION

The present invention contrives to solve the disadvantages and shortcomings of the prior art. The present invention provides a hood device used preferably in restaurants where food is cooked on a grill, a roaster, a stove and the like at a dining table, so as to inhale and ventilate the cooking fumes, smokes, odors, etc. that are generated from the dining table.

The object of the invention is to provide a hood device for a grill which includes a hood, a first grease collector, a telescoping tube for adjusting distance between the hood and the grill, a grease filter box, a filter, a second grease collector, and a spring balancer for allowing longitudinal movement of the telescoping tube and stabilizing the tube at a certain height. Due to the telescoping tube, the hood can be lowered adjacently to the grill to inhale cooking fumes, smokes, odors and the like that are generated while cooking the food. Then, the exhaust fumes travel through the telescoping tube to enter the grease filter box where any grease, dirt or debris that are contained in the fumes are filtered out by the filter and directed to the second grease collector. Any condensed grease dripping from internal surfaces of the telescoping tube and the hood is collected by the first grease collector that is attached to the hood. When a user is finished with using the hood, the telescoping tube is lifted up again and can be stabilized at a certain height due to the spring balancer.

Another object of the present invention is to provide a hood device for grill having a hood, a first grease collector, a telescoping tube for adjusting distance between the hood and the grill, and a spring balancer for allowing longitudinal movement of the telescoping tube and stabilizing the tube at a certain height. The spring balancer is attached, directly or indirectly, to a fixture, and a wire thereof is aligned non-coaxially with a central longitudinal axis of the telescoping tube so that the grease does not build up on the wire. When the telescoping tube along with the hood is lifted up to a certain height with certain force, the spring balancer stabilizes the telescoping tube at the height. The present invention may further comprise a stabilizing rod to more stabilize the longitudinal movement of the telescoping tube.

Still another object of the invention is to provide a hood device for grill having a hood, a first grease collector, a telescoping tube for adjusting distance between the hood and the grill, a grease filter box, a filter, and a second grease collector. The filter is received within the grease filter box in a slanted direction with respect to a gravitational direction, and directs grease, dirt, debris and the like from exhaust fumes down to the second grease collector due to a gravitational force. The filter is substantially isolated from the telescoping tube and the hood such that it does not disturb the longitudinal movement of the telescoping tube.

The advantages of the present invention are: (1) a hood can be positioned very closely to the grilling food to more effectively and efficiently collect cooking fumes, smokes, odors and the like from the grilling food; (2) a spring balancer of the present invention allows smooth and stable movement of the telescoping tube; (3) a wire of the spring balancer of the present invention is non-coaxially aligned with the telescoping tube to prevent grease, dirt, debris and the like from being accumulated therealong, which increases a durability of the wire; (4) a stabilizing rod of the present invention may prevent the telescoping tube from rocking side to side, and thus, enables more stable movement of the telescoping tube; (5) a filter of the present invention may collect grease, dirt, debris and the like from exhaust fumes, which provides more sanitary dining condition; (6) the filter is removably received within the grease filter box, and thus it is easy and convenient to clean, maintain or replace; (7) the filter and a second grease collector are received within the grease filter box which prevents the filter and the second grease collector from being dislodged and falling over the grilling area, which enhances sanitary condition of the dining table; (8) the filter is not sitting within the hood assembly so that the hood can be lowered even closer towards the grill; (9) the filter and the second grease collector are located above the telescoping tube, which decreases the overall weight of portions that a user needs to lift, and thus, enables easier and smoother movement of the telescoping tube; (10) the hood can be of smaller size due to being positioned closely to the grilling food, which allows a user to see the food clearly while the food is being grilled; (11) the present invention utilizes twist locks to connect the telescoping tube with the hood, or the hood with the grease collector, which permits safe and easier assembly and disassembly for maintenance; and (12) the present invention has a simple and integrated structure and the components of the present invention may be modularized, which enables easier and faster manufacturing process, lowers manufacturing costs.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view of a hood device for grill according to an embodiment of the present invention;

FIG. 2 is another perspective view of a hood device for grill according to an embodiment of the present invention;

FIG. 3 is a perspective view of a hood device for grill wherein a grease filter box is in an open position according to an embodiment of the present invention;

FIG. 4 is an exploded view of a hood device for grill according to an embodiment of the present invention;

FIG. 5 is an exploded view of a grease filter box of a hood device for grill according to an embodiment of the present invention;

FIG. 6 is a perspective view of a grease filter box of the hood device for grill wherein a filter is assembled within the grease filter box according to an embodiment of the present invention;

FIG. 7 is a perspective view of a filter receiving part of a hood device for grill according to an embodiment of the present invention;

FIG. 8 is a perspective view of a second grease collector of a hood device for grill according to an embodiment of the present invention;

FIG. 9 is an exploded view of a filter of a hood device for grill according to an embodiment of the present invention;

FIG. 10A is an enlarged view showing a filter receiving part and a filter installed in a grease filter box according to an embodiment of the present invention;

FIG. 10B is another enlarged view showing a filter receiving part and a filter installed in a grease filter box according to an embodiment of the present invention;

FIG. 11 is an exploded view of a telescoping tube, a hood, and a first grease collector of a hood device for grill according to an embodiment of the present invention; and

FIG. 12 is a perspective view of a spring balancer of a hood device for grill according to an embodiment of the present invention.

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

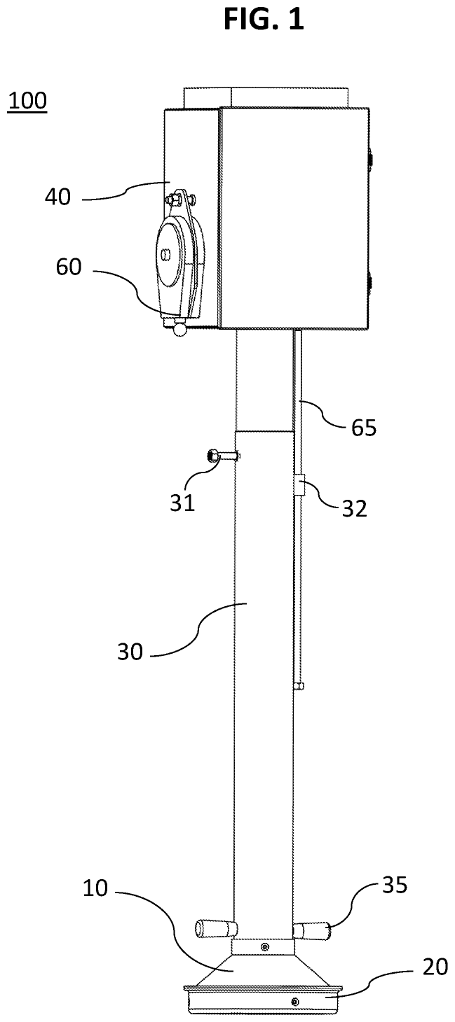

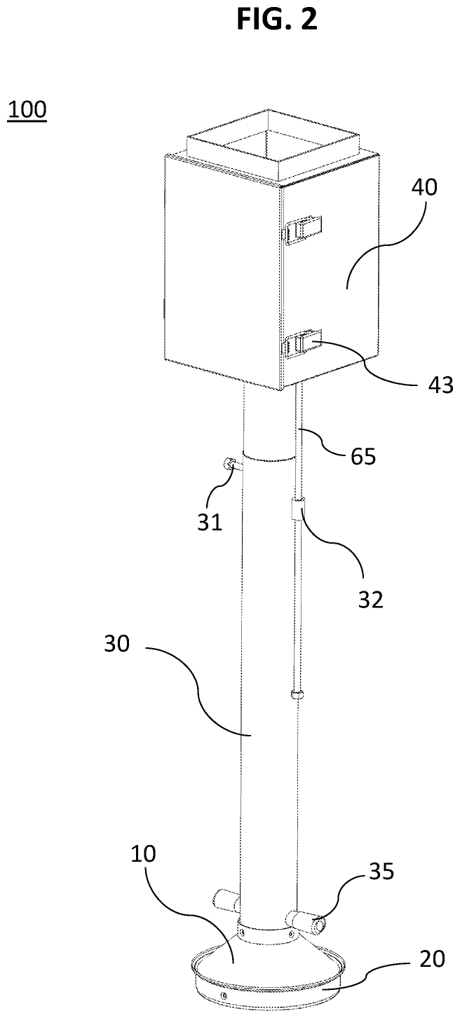

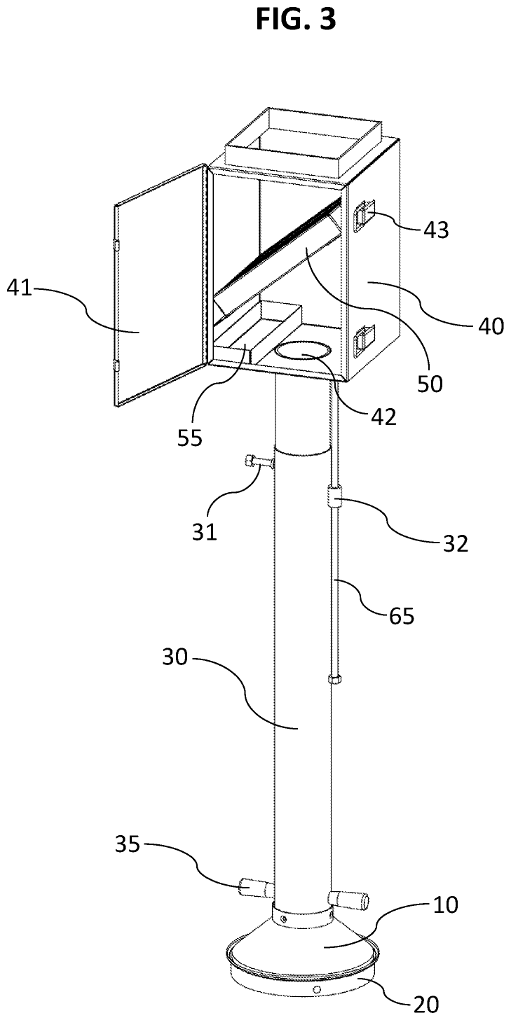

FIGS. 1-3 illustrate the hood device for grill in perspective views according to an embodiment. As shown in FIGS. 1-3, the hood device for grill 100 of the present invention comprises a hood 10, a first grease collector 20, a telescoping tube 30, a grease filter box 40, a filter 50, a second grease collector 55, and a spring balancer 60.

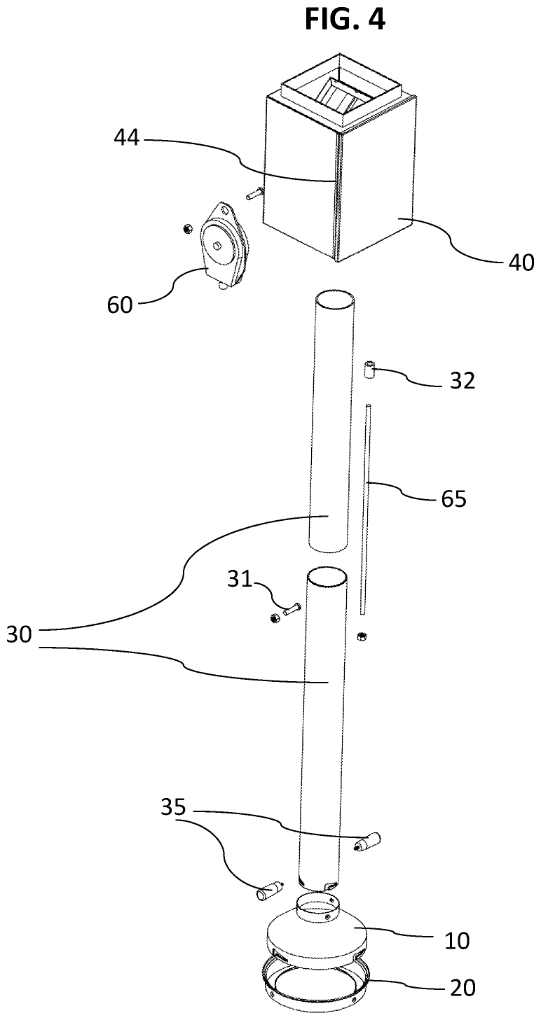

As shown in FIG. 4, one end of the hood 10 is connected to the first grease collector 20 that is constructed to collect any condensed grease, dirt and the like that are dripping from internal surfaces of the hood 10 and the telescoping tube 20. The other end of the hood 10 is connected to one end of the telescoping tube 30. The other end of the telescoping tube 30 is connected to the grease filter box 40 such that exhaust fumes from grilling food travel through the telescoping tube 30 and enter the grease filter box 40.

The telescoping tube 30 may comprise a plurality of tubes that are telescopically combined to adjust distance between the hood 10 and the grill. According to an embodiment, how long the telescoping tube 30 may be extended or shortened to depends on an overlapping height of the adjacent tubes of the telescoping tube 30. Preferably, the telescoping tube 30 has a minimum overlap of 10″ between the tubes. Due to the telescoping tube 30, the hood 10 can be lowered closely to the grill to more effectively inhale cooking fumes, smokes, odors and the like that are generated while cooking the food. Accordingly, the hood 10 may be smaller in diameter than conventional hoods. When a user is finished with using the hood 10, the telescoping tube 30 along with the hood 10 may be lifted up so that the user can more easily access to food, or dining space can be cleaned.

According to an embodiment, an insulated handle 35 may be installed at a lower portion of the telescoping tube 30 to raise or lower the telescoping tube 30, as shown in FIG. 4. Alternatively, the insulated handle 35 may be installed at the hood (10).

The spring balancer 60 may be attached to an outer surface of the grease filter box 40 as shown in FIG. 4. The spring balancer 60 comprises a wire (not shown) which can be connected to a wire receiving part 31 that is attached to the telescoping tube 30. When the telescoping tube 30 is lifted up or lowered down with a certain force, the spring balancer 60 may stabilize the telescoping tube 30 at a certain height that is determined by the force, and allows smoother longitudinal movement of the telescoping tube 30.

According to an embodiment, the hood device 100 may further comprise a stabilizing rod 65. If the telescoping tube 30 is supported by the spring balancer 60 only from one side, the wire may create a torque on the telescoping tube 30 and thus, the telescoping tube 30 may swing side to side. In order to minimize a swaying movement of the telescoping tube 30, the stabilizing rod 65 may be attached preferably to a bottom surface of the grease filter box 40, which is substantially parallel with a longitudinal axis of the telescoping tube 30, as shown in FIG. 4. At the same time, a rod receiving part 32 may be attached to the telescoping tube 30 such that the stabilizing rod 65 passes through the rod receiving part 32, which can maintain the longitudinal movement of the stabilizing rod 65 along with the telescoping tube 30, and prevent them from rocking side to side.

Preferably, the stabilizing rod 65 and the rod receiving part 32 are substantially cylindrical, and a diameter of the stabilizing rod 65 is smaller than a diameter of the rod receiving part 32. Alternatively, the stabilizing rod 65 may take a form of a prism or any other suitable shape, size, or configuration, and the rod receiving part 32 may take a form of a prism, a ring, or any other suitable shape, size or configuration, as long as a horizontal cross section of the stabilizing rod 65 is smaller than a horizontal cross section of the rod receiving part 32 so that the stabilizing rod 65 can longitudinally pass through the rod receiving part 32.

In another embodiment, instead of having the stabilizing rod 65 or the rod receiving part 32, the hood device 100 may comprise a plurality of spring balancers 60.

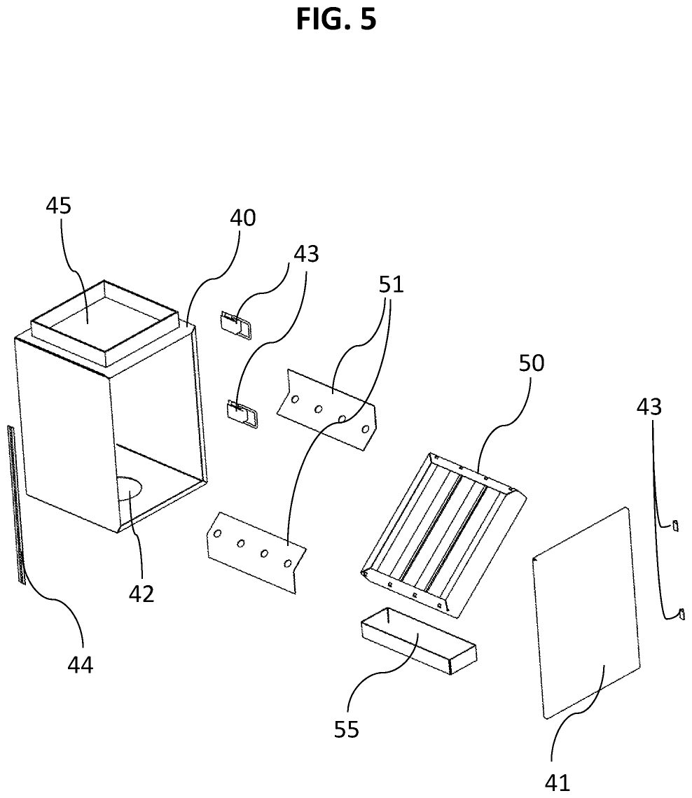

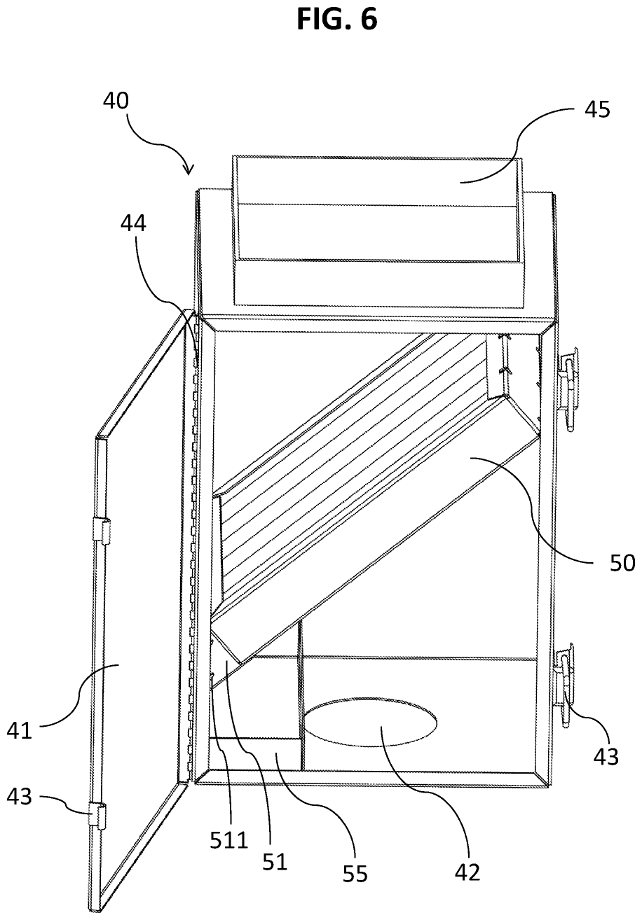

As shown in FIGS. 5-6, the grease filter box 40 is constructed to removably receive the filter 50 and the second grease collector 55. In this configuration, the filter 50 may be slanted at a substantial angle with respect to a gravitational direction, and the second grease collector 55 may be disposed below a lower end of the filter 50. Thus, once smokes or exhaust fumes enter the grease filter box 40 through a bottom opening 42 of the grease filter box 40, any grease, dirt or debris that are contained in the fumes can be filtered out by the filter 50, and can be directed to the second grease collector 55 by a gravitational force. In order to receive and maintain the filter 50 at its position, filter receiving parts 51 may be provided on opposed inner side surfaces of the grease filter box 40. The filter 50 may be mounted on the filter receiving parts 51.

The presence of the filter 50 and the second grease collector 55 within the grease filter box 40 dispenses the need for a filter or a bulky grease collector sitting within the hood which could take up a lot of vertical spaces; thus, the hood 10 of the present invention can be lighter in weight, and lowered even more safely and closely to the grill relative to conventional hood devices. Moreover, the filter 50 and the second grease collector 55 are still easily accessible and removable; thus, they are easy to clean, maintain or replace.

According to an embodiment, the grease filter box 40 may comprise an accessible door 41 to keep the filter 50 and the second grease collector 55 substantially isolated from the dining table. Such a structure may prevent any grease, dirt or debris that are collected in the grease filter box 40 from falling over the dining table; and thus, enhance sanitary condition of the dining area. Preferably, the accessible door 41 is connected to the grease filter box 40 by a hinge 44 so that the accessible door 41 can be easily and smoothly opened or closed. The hinge 44 may comprise a piano hinge as shown, in order to provide better support for the accessible door 41, and ensure the accessible door 41 and the grease filter box 40 can be aligned to reduce wear and tear. Alternatively, a plurality of short hinges may be used instead of the piano hinge. In addition, the grease filter box 40 may comprise locking means 43 to ensure that the accessible door 41 is kept closed. Alternatively, a sliding door (not shown) may be used instead of the hinged door 41.

According to an embodiment, the grease filter box 40 may comprise an exhaust riser 45 on a top portion thereof. Furthermore, a fire suppression system (not shown) may be provided within the grease filter box 40.

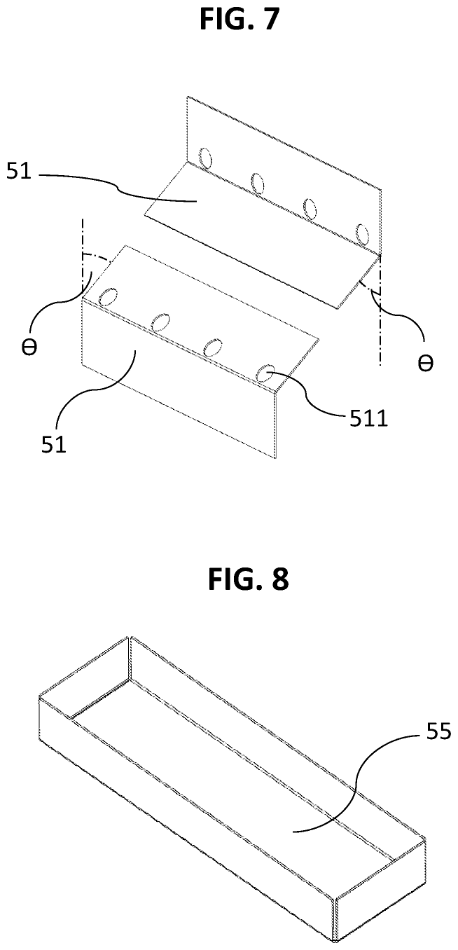

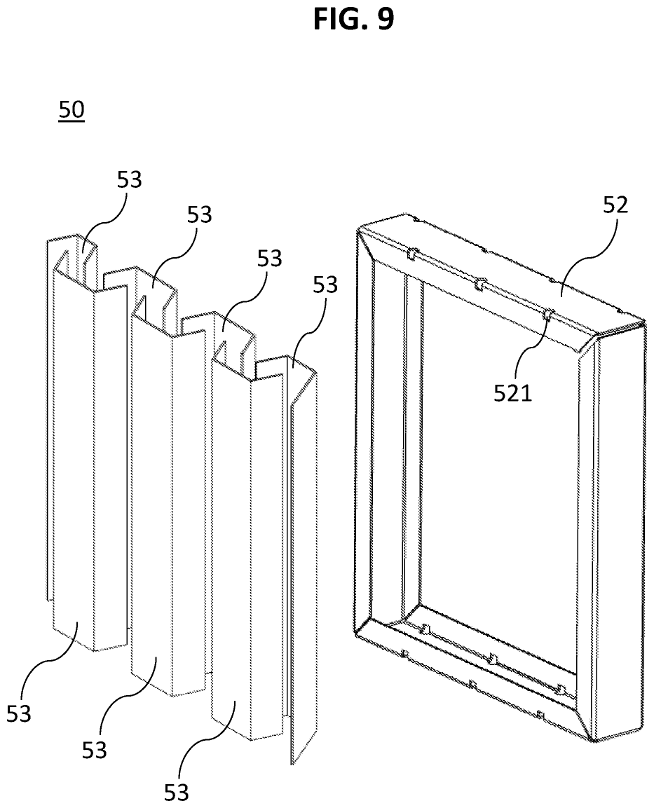

FIGS. 7 and 8 respectively illustrate the filter receiving parts 51 and the second grease collector 55. Preferably, an angle Θ between a gravitational direction and the filter receiving parts 51 may be substantially 45 degrees. However, the angle Θ may be any angle that is between 0 to 90 degrees so that the grease, dirt, or debris may run along the slanted filter 50 and fall to the second grease collector 55 by a gravitational force. The filter receiving parts 51 may comprise a plurality of holes 511 which allows the grease, dirt, debris and the like to be drained away to the second grease collector 50. As shown in FIG. 8, the second grease collector 55 is preferably a rectangular box, but may take any shape, size or configuration that can store the grease, dirt, debris and the like that are drained from the holes.

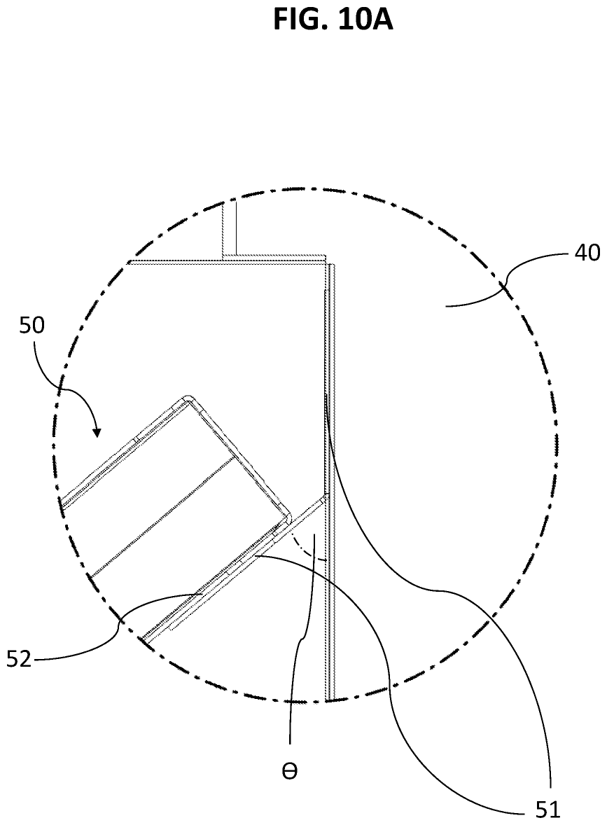

FIG. 9 illustrates the filter 50 according to an embodiment of the present invention. As shown in FIG. 9, the filter 50 may comprise a frame 52 and longitudinally extending strips 53. When assembled all together, the filter 50 may comprise substantially parallel multi-layers of the strips 53 extending between two sides of the frame 52. Preferably, the filter 50 may comprise two layers of the strips 53 that are substantially parallel to each other. According to an embodiment, each strip 53 has inwardly bent sides, and at least one bent side of the strips 53 in one layer is facing towards and overlapping with the strips 53 in the other layer. When the hood device 100 is in use, a longitudinal axis of each strip 53 may be slanted with respect to a gravitational direction so that grease, dirt, debris and the like can run along the strips 53.

The frame 52 may comprise a plurality of drain holes 521 on a lower side thereof to direct grease, dirt, debris and the like to the second grease collector 55 in the grease filter box 40. Preferably, a plurality of drain holes 521 may be provided along an upper side as well as the lower side thereof so that the filter 50 can be used upside down, as shown in FIG. 9. Furthermore, a plurality of drain holes 521 may be provided on both front and rear surfaces of the frame 52 so that the filter 50 can be used reversibly.

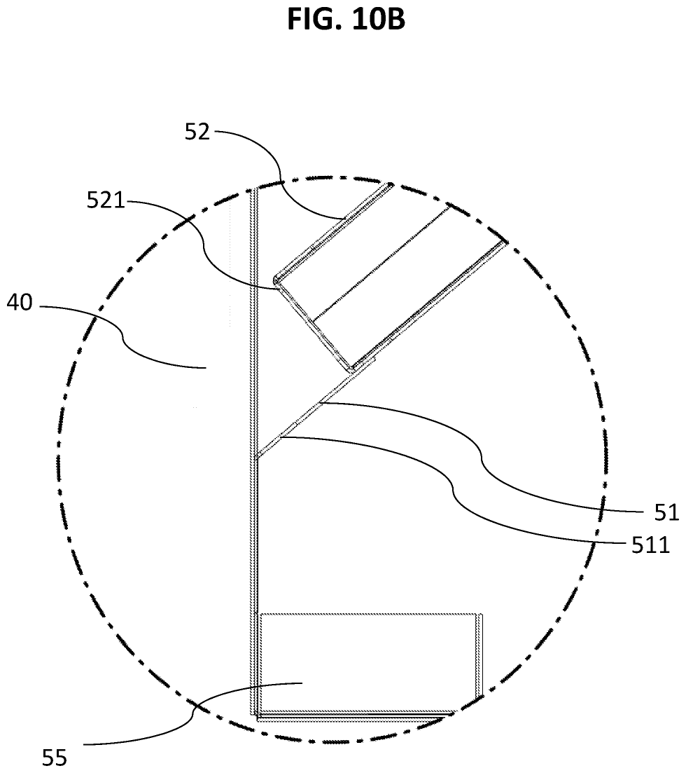

FIGS. 10A and 10B illustrate an enlarged view showing the filter receiving parts 51 and the filter 50 in an assembled state. As shown in FIG. 10A, an upper side of the frame 52 is mounted on the filter receiving part 51 such that the filter 50 is slanted with a substantial angle Θ with respect to a gravitational direction. In FIG. 10B, a lower side of the frame 52 is also mounted on the filter receiving part 51, but they are particularly constructed such that each drain hole 521 of the frame 52 is vertically aligned with a respective drain hole 511 of the filter receiving part 51. Thus, any grease, dirt, and debris and the like that are directed by the slanted strips 53 to the lower side of the frame 52 can be first drained out of the drain hole 521 of the frame 52, then drained out of the drain hole 511 of the filter receiving part 51, and finally fall to the second grease collector 55 that is disposed below the filter 50.

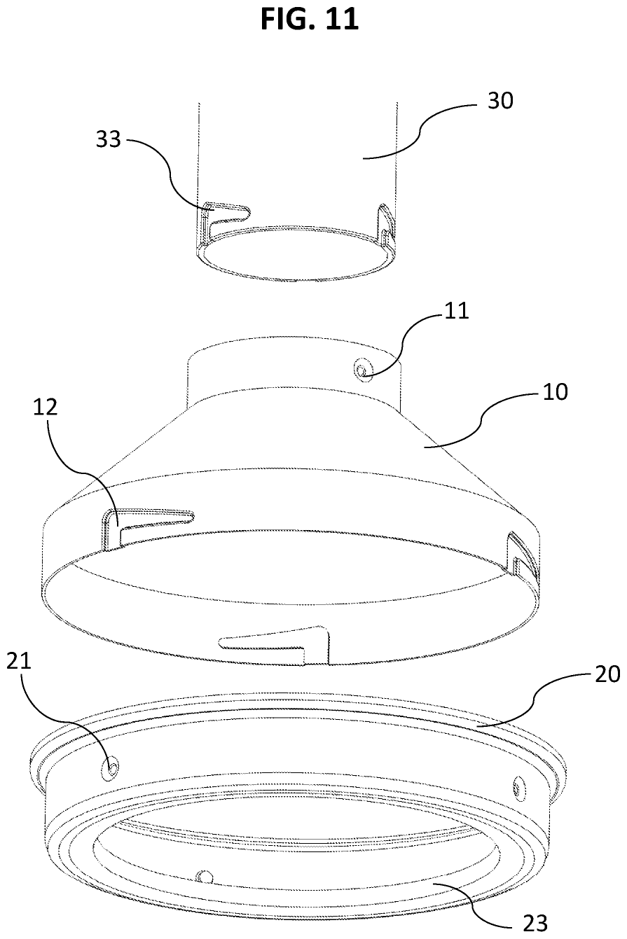

FIG. 11 is an exploded view of the telescoping tube 30, the hood 10, and the first grease collector 20 of the present invention. According to an embodiment, the hood 10 partially covers the grill at a certain distance from the grill, and inhales cooking fumes, smokes, odors and the like that are generated while cooking the food. Preferably, the hood 10 can be lowered to and positioned about 6 inches above the grill. The hood 10 may be preferably a truncated cone shape, or may be a truncated pyramid, a cylinder, or have any other suitable shape, size or configuration.

As shown in FIG. 11, the first grease collector 20 may be attached to the hood 10. Although a majority of grease, dirt, debris and the like are collected by the second grease collector 55 in the grease filter box 40, there may be some residues condensed along internal surfaces of the telescoping tube 30 or the hood 10. In order to prevent such residues from falling over the dining table, the first grease collector 20 may be provided along a periphery of the hood 10. In this configuration, the first grease collector 20 may comprise a peripheral recess 23 extending inwardly from a peripheral edge thereof. Accordingly, any condensed grease dripping from internal surfaces of the telescoping tube 30 or the hood 10 can be collected by the peripheral recess 23 of the first grease collector 20. Therefore, a presence of the filter 50, the second grease collector 55, and the first grease collector 55 all together ensures an improved sanitation and more effective collection of grease.

Preferably, the first grease collector 20 may be secured to the hood 10 using a twist lock. As shown in FIG. 11, the first grease collector 20 may comprise locking protrusions 21, and the hood 10 may comprise locking grooves 12 at a lower portion thereof. Alternatively, the first grease collector 20 may comprise locking grooves and the hood 10 may comprise locking protrusions. In any configuration, each locking protrusion 21 is constructed to be connected to a respective locking groove 12.

Similarly, the hood 10 may further comprise locking protrusions 11 at an upper portion thereof, and the telescoping tube 30 may comprise locking grooves 33. Alternatively, the hood 10 may comprise locking grooves at the upper portion thereof, and the telescoping tube 30 may comprise locking protrusions. In any configuration, each locking protrusion 21 is constructed to be connected to a respective locking groove 12.

The twist lock structure of the present invention permits safer and easier assembly and disassembly for maintenance. Alternatively, a rotational screw closure (not shown) may be used instead of the twist lock.

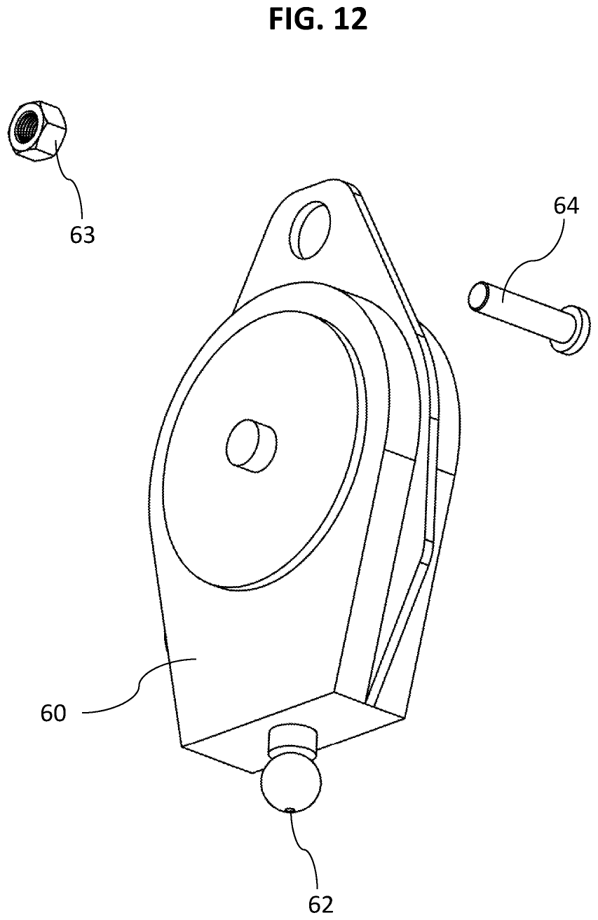

FIG. 12 illustrates the spring balancer 60 of the present invention. According to an embodiment, the spring balancer 60 is attached to an outer surface of the grease filter box 40, preferably using a lock nut 63 and bolt 64. Alternatively, a wing nut or any appropriate means which is capable of attaching the spring balancer 60 to the grease filter box 40 may be used. In this configuration, the spring balancer 60 may comprise a wire (not shown) that is coiled inside the spring balancer 60, and an opening 62 through which the wire comes out of the spring balancer 60. The wire of the spring balancer 60 is connected to the wire receiving part 31 that is attached to the telescoping tube 30 so as to allow smoother longitudinal movement of the telescoping tube 30, and maintain the telescoping tube 30 at a certain distance from cooking appliance. In this configuration, the wire of the spring balancer 60 is located externally to the telescoping tube 30; thus, grease does not accumulate upon the wire that could hinder an operation of the telescoping tube 30. Moreover, this structure may increase a durability of the wire.

In another embodiment, the spring balancer may be attached, directly or indirectly, to a fixture. The fixture may be a wall, a ceiling or any support structure which the spring balancer 60 can be stably attached to. In this configuration, the wire of the spring balancer 60 may be aligned non-coaxially with a longitudinal axis of the telescoping tube 30 so that the grease does not accumulate upon the wire that could hinder an operation of the telescoping tube 30. Additionally, the stabilizing rod 65 may be provided and attached, directly or indirectly, to the fixture in a substantially parallel direction with respect to a longitudinal axis of the telescoping tube 30, in order to minimize a horizontal swaying movement of the telescoping tube 30. For this, the rod receiving part 32 may be attached to the telescoping tube 30 and constructed such that the stabilizing rod 65 passes through the rod receiving part 32, which can maintain the longitudinal movement of the stabilizing rod 65 along with the telescoping tube 30, and prevent them from rocking side to side.

Preferably, the stabilizing rod 65 and the rod receiving part 32 are substantially cylindrical, and a diameter of the stabilizing rod 65 is smaller than a diameter of the rod receiving part 32. Alternatively, the stabilizing rod 65 may take a form of a prism or any other suitable shape, size, or configuration, and the rod receiving part 32 may also take a form of a prism, a ring, or any other suitable shape, size or configuration, as long as a horizontal cross section of the stabilizing rod 65 is smaller than a horizontal cross section of the rod receiving part 32 so that the stabilizing rod 65 can longitudinally pass through the rod receiving part 32.

Instead of having the stabilizing rod 65 or the rod receiving part 32, the embodiment may comprise a plurality of spring balancers 60.

The hood 10 may preferably comprise stainless steel. The telescoping tube 30 may preferably comprise stainless steel. The first grease collector 30 and the second grease collector 55 may preferably comprise stainless steel. The filter 50 including the frame 52 and strips 53 may preferably comprise galvanized steel. The stabilizing rod 65 may preferably comprise stainless steel. The insulated handle 35 may preferably comprise phenol. In certain embodiments of the invention, the above-mentioned components of the hood device 100 may be made of some other strong material which can withstand heat from the grill.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A hood device for grill, comprising:
a hood wherein a first grease collector is attached to the hood;
a telescoping tube for adjusting distance between the hood and the grill, wherein one end of the telescoping tube is connected to the hood;
a grease filter box connected to the other end of the telescoping tube;
a filter removably received within the grease filter box in a slanted direction with respect to a gravitational direction;
a second grease collector removably received within the grease filter box;
a spring balancer attached to an outer surface of the grease filter box for allowing longitudinal movement of the telescoping tube and stabilizing the tube at a certain height.

2. The hood device of claim 1, wherein the grease filter box comprises an accessible door,
wherein filter receiving parts are attached to inner side surfaces of the grease filter box,
wherein the filter is mounted on the filter receiving parts,
wherein the grease filter box comprises a bottom opening through which smokes from the telescoping tube enter the grease filter box.

3. The hood device of claim 1, wherein the spring balancer comprises a wire that is connected to a wire receiving part of the telescoping tube.

4. The hood device of claim 3, wherein a stabilizing rod is attached to the grease filter box,
wherein a longitudinal axis of the stabilizing rod is substantially parallel with a longitudinal axis of the telescoping tube,
wherein a rod receiving part is attached to the telescoping tube,
wherein a horizontal cross section of the stabilizing rod is smaller than a horizontal cross section of the rod receiving part,
wherein the stabilizing rod passes through the rod receiving part to maintain a longitudinal movement of the telescoping tube.

5. The hood device of claim 4, wherein the stabilizing rod is substantially in a form of a cylinder or a prism,
wherein the rod receiving part is substantially in a form of a cylinder, a prism or a ring.

6. The hood device of claim 1, wherein the filter comprises a frame and substantially parallel multi-layers of longitudinally extending strips,
wherein the strips are extending between two sides of the frame,
wherein each strip is slanted with respect to the gravitational direction and has inwardly bent sides,
wherein at least one bent side of the strips in one layer are facing towards and overlapping with the strips in the other layer,
wherein the frame comprises drain holes along a lower side thereof to direct grease to the second grease collector in the grease filter box.

7. The hood device of claim 6, wherein the frame further comprises drain holes along an upper side thereof so that the filter can be used upside down.

8. The hood device of claim 1, wherein the first grease collector is secured to the hood using a twist lock.

9. The hood device of claim 1, wherein the first grease collector comprises a peripheral recess extending inwardly from a peripheral edge thereof.

10. The hood device of claim 1, wherein a handle is installed at a lower portion of the telescoping tube, or at the hood.

11. A hood device for grill, comprising:
a hood wherein a first grease collector is attached to the hood;
a telescoping tube for adjusting distance between the hood and the grill, wherein one end of the telescoping tube is connected to the hood;
a spring balancer for allowing longitudinal movement of the telescoping tube and stabilizing the tube at a certain height,
wherein the spring balancer is attached, directly or indirectly, to a fixture,
wherein the spring balancer comprises a wire that is connected to a wire receiving part of the telescoping tube,
wherein a wire of the balancer is aligned non-coaxially with a longitudinal axis of the telescoping tube.

12. The hood device of claim 11, wherein a stabilizing rod is attached to the grease filter box,
wherein a longitudinal axis of the stabilizing rod is substantially parallel with a longitudinal axis of the telescoping tube,
wherein a rod receiving part is attached to the telescoping tube,
wherein a horizontal cross section of the stabilizing rod is smaller than a horizontal cross section of the rod receiving part,
wherein the stabilizing rod passes through the rod receiving part to maintain a longitudinal movement of the telescoping tube.

13. The hood device of claim 12, wherein the stabilizing rod is substantially in a form of a cylinder or a prism,
wherein the rod receiving part is substantially in a form of a cylinder, a prism or a ring.

14. The hood device of claim 11, wherein a handle is installed at a lower portion of the telescoping tube, or at the hood.

15. A hood device for grill, comprising:
a hood wherein a first grease collector is attached to the hood;
a telescoping tube for adjusting distance between the hood and the grill, wherein one end of the telescoping tube is connected to the hood;
a grease filter box connected to the other end of the telescoping tube;
a filter removably received within the grease filter box in a slanted direction with respect to a gravitational direction;
a second grease collector removably received within the grease filter box.

16. The hood device of claim 15, wherein the grease filter box comprises an accessible door,
wherein filter receiving parts are attached to inner side surfaces of the grease filter box,
wherein the filter is mounted on the filter receiving parts,
wherein the grease filter box comprises a bottom opening through which smokes from the telescoping tube enter the grease filter box.

17. The hood device of claim 15, wherein the filter comprises a frame and substantially parallel multi-layers of longitudinally extending strips,
wherein the strips are extending between two sides of the frame,
wherein each strip is slanted with respect to the gravitational direction and has inwardly bent sides,
wherein at least one bent side of the strips in one layer are facing towards and overlapping with the strips in the other layer,
wherein the frame comprises drain holes along a lower side thereof to direct grease to the second grease collector in the grease filter box.

18. The hood device of claim 17, wherein the frame further comprises drain holes along an upper side thereof so the filter can be used upside down.

19. The hood device of claim 15, wherein the first grease collector comprises a peripheral recess extending inwardly from a peripheral edge thereof.

20. The hood device of claim 15, wherein the first grease collector is secured to the hood using a twist lock.
